(19) United States
(12) Patent Application Publication
(10) Pub. No.: US 2026/0353036 A1
(43) Pub. Date: Nov. 5, 2026

(54) ENTERPRISE DEVICE OBSERVABILITY AND GEOGRAPHIC LOCATION-BASED SERVICE

(71) Applicant: Telefonaktiebolaget LM Ericsson (publ), Stockholm (SE)

(72) Inventor: Rongrong WEN, Stockholm (SE)

(73) Assignee: Telefonaktiebolaget LM Ericsson (publ), Stockholm (SE)

(21) Appl. No.: 19/488,629

(22) PCT Filed: Jun. 7, 2024
(86) PCT No.: PCT/IB2024/055612

§ 371 Date: Nov. 27, 2025

Related U.S. Application Data
(60) Provisional application No. 63/506,951, filed on Jun. 8, 2023.

(51) Int. Cl. H04W 4/029

(52) U.S. Cl. CPC H04W 4/029

(57) ABSTRACT

A location validation server in a communication system configured for validating service requests associated with a wireless device is provided. The location validation server is configured to receive network estimated location information for the wireless device, as provided by a Gateway Mobile Location Centre. The location validation server further validates the received location information against the service request. Depending on the outcome of this validation, the location validation server either modifies a Network Slice Selection Assistance Information through a Policy Control Function or alters a User Data Management subscriber profile. The location validation server is further configured to report real-time performance metrics for the wireless device.

### FIELD

The present disclosure relates to wireless communications, and in particular, to configurations for supporting enterprise device observability and geographic location based servicing

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

To harness the potential of 5G technology and allow providers the opportunity to monetize their investment, there may be a significant complexity associated with the end-to-end use of 5G network slicing. This challenge demands a thorough understanding of both Telecommunication (Telco) and Transport networks.

### Observability

Existing methods either fail to offer performance insights segmented by Transport and Telco sides, or they do not generate real-time performance reports at the device level, e.g., with a refresh rate of one second or less.

### Location-Based Service Management

Existing location-based service methodologies primarily utilize the Presence Reporting Area (PRA). Decisions are based on parameters such as Public Land Mobile Network (PLMN), tracking areas, cell identifiers, or Local Area Data Network DNN. However, a wireless device (e.g., User Equipment (UE)) might physically be in a first tracking area (TA), e.g., TA1, but connects to cells in TA2 due to geographical or environmental factors, such as having a direct line of sight to a distant tower on a high hill. Such circumstances may lead to poor user experiences within the service area, and the service area's accuracy may become hard to define in relation to the actual geographical location.

### SUMMARY

Some embodiments advantageously provide methods, systems, and apparatuses for supporting enterprise device observability and geographic location based servicing.

Some embodiments of the present disclosure provide a comprehensive strategy bridging the gap between the Telco, i.e., service provider, and Transport networks. Embodiments may enhance the service capability end-to-end, with added benefits such as device-level observability and security. Embodiments may facilitate service ordering with geographic tracking and methods of service delivery.

Some embodiments may be deployed at the Telco edge, leveraging the capabilities of software defined wide area network (SD-WAN) technology, for example, to monitor both the WD device end and customer backend service continually. This information may be fed by network intelligence from the Telco. The security service edge (SSE) edge device may also act as a probe, persistently monitoring device throughput. For example, this data may be transmitted to an external portal dashboard via a developed representational state transfer (REST) application programming interface (API).

Embodiments may enable a service management ability to activate and deactivate services based on the geographical location of the WD. Different methods may be provided for 5G Standalone (SA) and Non-Standalone (NSA) scenarios, for example.

Some embodiments may employ an agentless approach to gather device-level performance data from both the Telco side (e.g., RAN+Core) and the Transport side. Real-time performance, including throughput, latency, jitter, and/or Quality of Experience (QoE) per device level, may be reported through an API, as described herein.

In some embodiments, a Location Service (LCS) validation server periodically retrieves location information via an API interface, using either the WD location or validated service area information. The Gateway Mobile Location Centre (GMLC) may provide network-estimated location information for the WD to validate against the service request. The control point for service management may vary. For 5G SA, for example, it may be based on Network Slice Selection Assistance Information (NSSAI) modification through the Policy Control Function (PCF). For 5G NSA, for example, it may be based on User Data Management (UDM) subscriber profile modification through the Exposure Data and Analytics (EDA).

Embodiments of the present disclosure may advantageously serve as a real-time probe at the Telco edge, leveraging SD-WAN technology, for example, to continuously monitor the network performance of both devices and backend enterprise servers. This may facilitate real-time observability at both the Telco and Transport edges, e.g., without requiring an agent.

Embodiments of the present disclosure may advantageously require only minimal additional traffic to monitor current network performance in real-time at the device level for both the Telco network and the transport network. Furthermore, some embodiments may be network-agnostic, meaning they can be utilized across all types of SIM-enabled networks, for example.

Embodiments of the present disclosure may provide a method and interface for managing location-based services based on network-estimated geographical locations. These embodiments may advantageously offer the flexibility to define services according to geographic needs, with network partitioning occurring at the cluster level for coverage, for example.

Some embodiments may enable the utilization of premium network services based on the WD's geographical location, while maintaining network resource partitioning or slicing across a wide area, for example.

According to one aspect of the present disclosure, a method implemented in a location validation server in a communication system configured to communicate with a wireless device is provided. Network estimated location information for the wireless device is received and is provided by a Gateway Mobile Location Centre, GMLC. The received network estimated location information is validated against a service request. One of the following is modified based on the validation: a Network Slice Selection Assistance Information, NSSAI, through a Policy Control Function, PCF, and a User Data Management, UDM, subscriber profile. Real-time performance metrics for the wireless device are reported.

According to one or more embodiments of this aspect, the real-time performance metrics include one or more of throughput, latency, jitter and Quality of Experience, QoE, metrics.

According to one or more embodiments of this aspect, the real-time performance metrics are at a device level for the wireless device.

According to one or more embodiments of this aspect, the real-time performance metrics are derived from both a Radio Access Network, RAN, and a core transport side of the communication system.

According to one or more embodiments of this aspect, the modifying of the NSSAI through the PCF comprises one of: deactivation of a location based service; and activation of a location based service.

According to one or more embodiments of this aspect, the modifying of the UDM subscriber profile comprises one of: deactivation of a location based service; and activation of a location based service.

According to another aspect of the present disclosure, a location validation server in a communication system configured to communicate with a wireless device is provided. The location validation server comprises processing circuitry configured to receive network estimated location information for the wireless device provided by a Gateway Mobile Location Centre, GMLC, validate the received network estimated location information against a service request, modify, based on the validation, one of a Network Slice Selection Assistance Information, NSSAI, through a Policy Control Function, PCF, and a User Data Management, UDM, subscriber profile, and report real-time performance metrics for the wireless device.

According to one or more embodiments of this aspect, the real-time performance metrics include one or more of throughput, latency, jitter and Quality of Experience, QoE, metrics.

According to one or more embodiments of this aspect, the real-time performance metrics are at a device level for the wireless device.

According to one or more embodiments of this aspect, the real-time performance metrics are derived from both a Radio Access Network, RAN, and a core transport side of the communication system.

According to one or more embodiments of this aspect, the modifying of the NSSAI through the PCF comprises one of: deactivation of a location based service; and activation of a location based service.

According to one or more embodiments of this aspect, the modifying of the UDM subscriber profile comprises one of: deactivation of a location based service; and activation of a location based service.

According to another aspect of the present disclosure, a method implemented in a Policy Control Function, PCF, in a communication system configured to communicate with a location validation server is provided. A request is received for modification of a Network Slice Selection Assistance Information, NSSAI, based on the validation of network estimated location information for a wireless device by the location validation server. The NSSAI is modified based on the received request. The modified NSSAI is provided for service request management of the wireless device.

According to one or more embodiments of this aspect, the NSSAI modification request is influenced by one or more real-time performance metrics for the wireless device including one or more of throughput, latency, jitter, and Quality of Experience, QoE, metrics.

According to one or more embodiments of this aspect, the real-time performance metrics are at a device level for the wireless device.

According to one or more embodiments of this aspect, the real-time performance metrics influencing the NSSAI modification request are derived from both a Radio Access Network, RAN, and a core transport side of the communication system.

According to one or more embodiments of this aspect, the NSSAI modification request comprises one of: deactivation of a location based service; and activation of a location based service.

According to another aspect of the present disclosure, a Policy Control Function, PCF, in a communication system configured to communicate with a location validation server is provided. The PCF comprises processing circuitry configured to receive a request for modification of a Network Slice Selection Assistance Information, NSSAI, based on the validation of network estimated location information for a wireless device, by the location validation server, modify the NSSAI based on the received request, and provide the modified NSSAI for service request management of the wireless device.

According to one or more embodiments of this aspect, the NSSAI modification request is influenced by one or more real-time performance metrics for the wireless device including one or more of throughput, latency, jitter, and Quality of Experience, QoE, metrics.

According to one or more embodiments of this aspect, the real-time performance metrics are at a device level for the wireless device.

According to one or more embodiments of this aspect, the real-time performance metrics influencing the NSSAI modification request are derived from both a Radio Access Network, RAN, and a core transport side of the communication system.

According to one or more embodiments of this aspect, the NSSAI modification request comprises one of: deactivation of a location based service; and activation of a location based service.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network according to the principles in the present disclosure;

FIG. 2 is a block diagram of a network node communicating with a wireless device over an at least partially wireless connection according to some embodiments of the present disclosure;

FIG. 3 is a flowchart of an example process in a location validation server for supporting enterprise device observability and geographic location based servicing according to some embodiments of the present disclosure;

FIG. 4 is a flowchart of an example process in a policy control function (PCF) for supporting enterprise device observability and geographic location based servicing according to some embodiments of the present disclosure;

FIG. 5 is a block diagram illustrating an example embodiment of the present disclosure for a live video capture application using a 5G slicing end-to-end configuration;

FIG. 6 is an illustration of an example user interface for managing 5G slicing end-to-end, according to embodiments of the present disclosure;

FIG. 7 is another illustration of an example user interface for managing 5G slicing end-to-end, according to embodiments of the present disclosure;

FIG. 8 is a block diagram illustrating an example for device payload traffic flow for device performance observability, according to some embodiments of the present disclosure;

FIG. 9 is a flowchart illustrating an example process for location-based service validation, according to some embodiments of the present disclosure;

FIG. 10 is a flowchart illustrating another example process for location-based service validation, according to some embodiments of the present disclosure;

FIG. 11 is a flowchart illustrating another example process for location-based service validation, according to some embodiments of the present disclosure;

FIG. 12 is a flowchart illustrating another example process for location-based service validation, according to some embodiments of the present disclosure; and

FIG. 13 is a flowchart illustrating another example process for location-based service validation, according to some embodiments of the present disclosure.

### DETAILED DESCRIPTION

Before describing in detail example embodiments, it is noted that the embodiments reside primarily in combinations of apparatus components and processing steps related to supporting enterprise device observability and geographic location based servicing. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for supporting enterprise device observability and geographic location based servicing

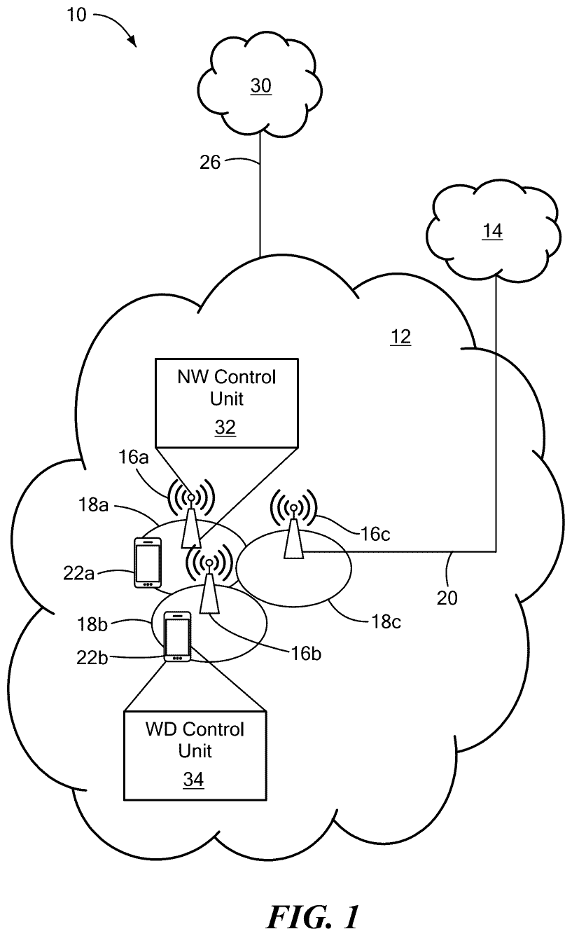

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network (RAN), and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

A network node 16 is configured to include a NW control unit 32 which is configured for supporting enterprise device observability and geographic location based servicing. A wireless device 22 is configured to include a WD control unit 34 which is configured for supporting enterprise device observability and geographic location based servicing.

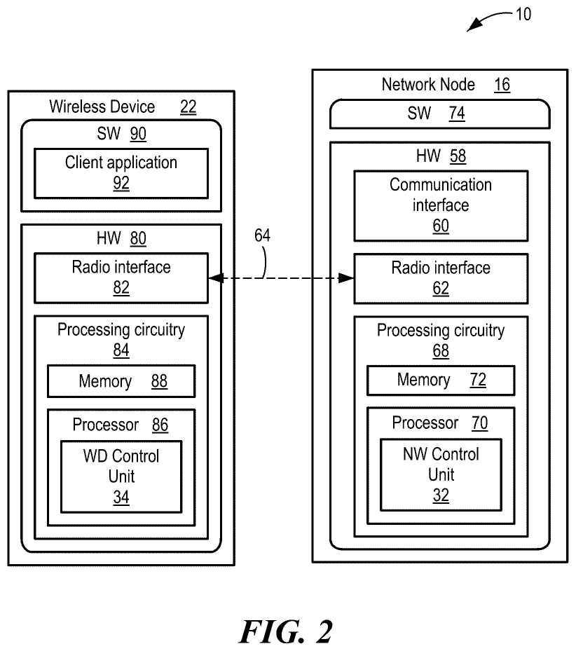

Example implementations, in accordance with an embodiment, of the WD 22, and network node 16 discussed in the preceding paragraphs will now be described with reference to FIG. 2.

The communication system 10 includes a network node 16 provided in a communication system 10 and including hardware 58 enabling it to communicate with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NW control unit 32 configured for supporting enterprise device observability and geographic location based servicing.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD control unit 34 configured for supporting enterprise device observability and geographic location based servicing.

In some embodiments, the inner workings of the network node 16 and WD 22 may be as shown in FIG. 2 and independently, the surrounding network topology may be that of FIG. 1.

Network infrastructure may determine the routing, which it may be configured to hide from the WD 22.

The wireless connection 64 between the WD 22 and the network node 16 is in accordance with the teachings of the embodiments described throughout this disclosure.

In some embodiments, a measurement procedure may be provided for the purpose of monitoring data rate, latency and other factors on which the one or more embodiments improve.

In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or
preparing/terminating/maintaining/supporting/ending in receipt of a transmission from the network node 16.

Although FIGS. 1 and 2 show various “units” such as NW control unit 32, and WD control unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

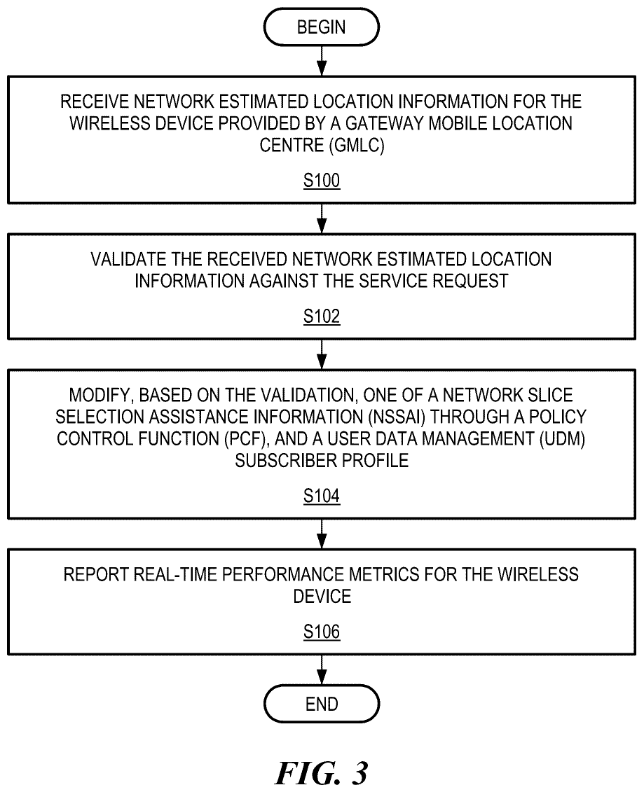

FIG. 3 is a flowchart of an example process in a location validation server (e.g., as implemented in a network node 16) for supporting enterprise device observability and geographic location based servicing. One or more blocks described herein may be performed by one or more elements of location validation server (network node 16) such as by one or more of processing circuitry 68 (including the NW control unit 32), processor 70, radio interface 62 and/or communication interface 60. Location validation server is configured to receive (Block S100) network estimated location information for the WD 22 provided by a Gateway Mobile Location Centre (GMLC). Location validation server is configured to validate (Block S102) the received network estimated location information against the service request. The location validation server is configured to modify (Block S104), based on the validation, either a Network Slice Selection Assistance Information (NSSAI) through a Policy Control Function (PCF), or a User Data Management (UDM) 122 subscriber profile. The location validation server is configured to report (Block S106) real-time performance metrics for the WD 22.

In some embodiments, the real-time performance metrics include one or more of throughput, latency, jitter and Quality of Experience (QoE) metrics. In some embodiments, the real-time performance metrics are derived from both a Radio Access Network (RAN) 12 and a core 14 transport side of the communication system. In some embodiments, the real-time performance metrics are derived from both a RAN 12 and a core 14 transport side of the communication system. In some embodiments, the modifying of the NSSAI through the PCF 116 comprises one of deactivation of a location based service and activation of a location based service. In some embodiments, the modifying of the UDM 122 subscriber profile comprises one of deactivation of a location based service and activation of a location based service.

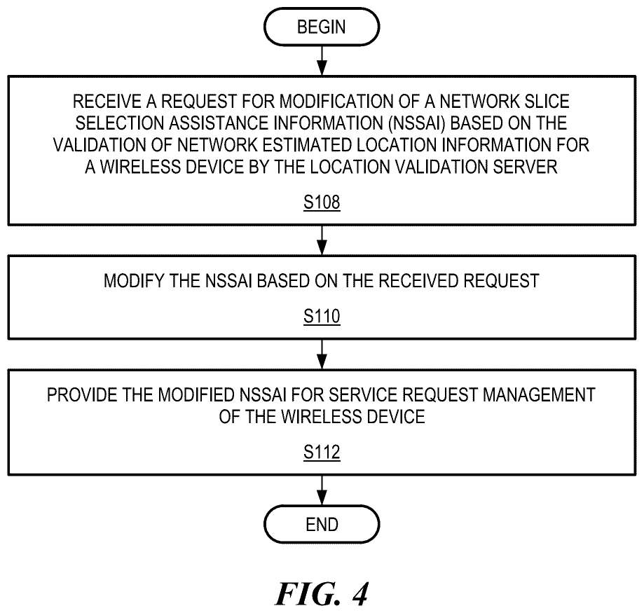

FIG. 4 is a flowchart of an example process in a PCF (e.g., as implemented in a network node 16) for supporting enterprise device observability and geographic location based servicing. One or more blocks described herein may be performed by one or more elements of PCF (network node 16) such as by one or more of processing circuitry 68 (including the NW control unit 32), processor 70, radio interface 62 and/or communication interface 60. PCF is configured to receive (Block S108) a request for modification of a Network Slice Selection Assistance Information (NSSAI) based on the validation of network estimated location information for a wireless device (WD) by the location validation server. PCF is configured to modify (Block S110) the NSSAI based on the received request. PCF is configured to provide (Block S112) the modified NSSAI for service request management of the WD.

In some embodiments, the NSSAI modification request is influenced by one or more real-time performance metrics for the WD 22 including one or more of throughput, latency, jitter, and Quality of Experience (QoE) metrics. In some embodiments, the real-time performance metrics influencing the NSSAI modification request are derived from both a Radio Access Network (RAN) 12 and a core 14 transport side of the communication system. In some embodiments, the real-time performance metrics are at a device level for the wireless device 22. In some embodiments, the NSSAI modification request comprises one of deactivation of a location based service and activation of a location based service.

Having described the general process flow of arrangements of the disclosure and having provided examples of hardware and software arrangements for implementing the processes and functions of the disclosure, the sections below provide details and examples of arrangements for supporting enterprise device observability and geographic location based servicing.

Some embodiments provide configurations for supporting enterprise device observability and geographic location based servicing.

An Enterprise end-to-end (E2E) Service Level Agreement solution (Enterprise e2e SLA solution) may be appropriate for some wide-area critical communication applications and provides premium service capability via an enterprise-level controllable network provided by an operator macro network. Embodiments of the present disclosure may enable real-time device-level observability and connectivity security tunnelling with relatively modest investment.

Embodiments of the present disclosure may enable network slicing with a reserved radio partitioning for defined devices, powered by Radio Access Network (RAN) combined features for shared RAN and dynamic resource allocation. The radio resource may be dynamic, allowing for added flexibility within mobile broadband sharing the same frequency. For the last mile of enterprise connectivity and security, embodiments of the present disclosure may bridge the gap from the Telco edge to the enterprise backend server by providing a resolution with secure SD-WAN technology.

A compatible E2E solution may be used as a macro production network (or Private network and Fixed wireless, for example) to provide a seamless guaranteed transmission.

Embodiments of the present disclosure may provide a reporting API interface and a bespoke dashboard allowing for user observability on a per device level, which may provide a network operator or user with real-time observability of a single-camera level throughput, on latency, jitter, and packet loss-reporting on performance as it happens, for example.

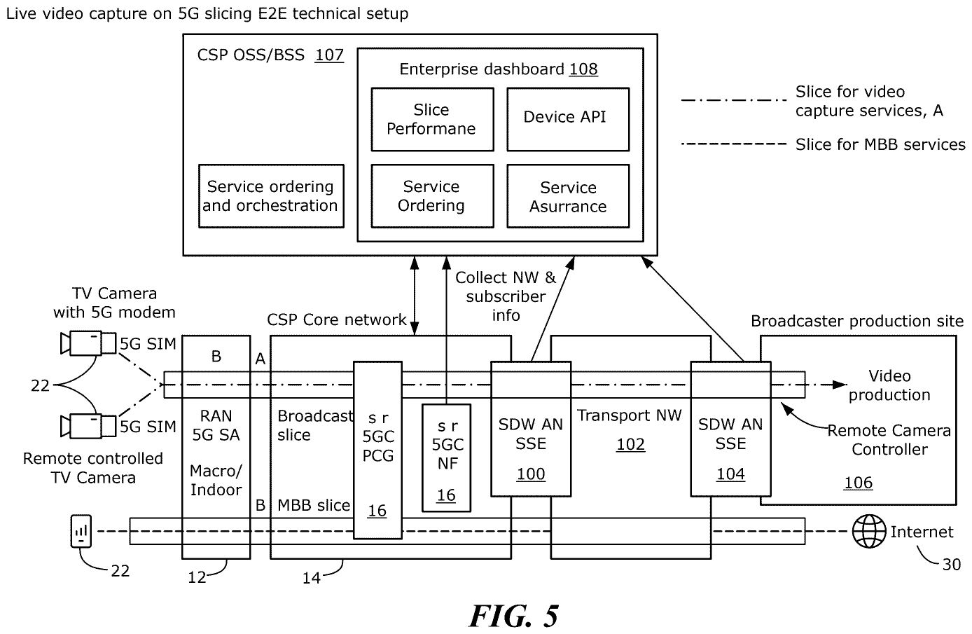

FIG. 5 is a block diagram illustrating an example embodiment of the present disclosure for a live video capture application using a 5G slicing end-to-end configuration. In the example of FIG. 5, two cameras are provided, which may be and/or may include wireless devices 22, e.g., with integrated 5G modems and 5G Subscriber Identity Module (SIM) cards. These cameras may be operated remotely and are capable of transmitting video data to a Radio Access Network (RAN) 12 designed for 5G Standalone Architecture (5G SA) Macro/Indoor deployments, for example.

The cameras are configured for transmitting a slice for video capture services A, i.e., a “broadcast slice”. This slice is relayed from the RAN 5G SA 12 to a Communication Service Provider (CSP) Core Network 14, specifically targeting a module defined as the Service-based 5G Core (5GC) Policy Control function Group (PCG) (e.g., implemented in a network node 16 and/or other remote node, virtual node, core node, cloud node, server, etc.).

The broadcast slice is dispatched to a first Software Defined Wide Area Network (SDWAN) Service Edge (SSE) 100 (e.g., implemented in a network node 16 and/or other remote node, virtual node, core node, cloud node, server, etc.) at the transport network 102 (e.g., implemented in a network node 16 and/or other remote node, virtual node, core node, cloud node, server, etc.), then to a second SDWAN SSE 104 (e.g., implemented in a network node 16 and/or other remote node, virtual node, core node, cloud node, server, etc.), destined ultimately for a broadcaster production site (e.g., a network node 16, or other computing servers, nodes, etc.) 106. The customer domain backend (e.g., broadcaster production site) 106 comprises a remote camera controller and video production systems designed to receive, process, and utilize the broadcast slice.

In a parallel process, a wireless device 22 (e.g., a mobile smartphone) dispatches signaling data to the RAN 5G SA 12. This is identified as the Mobile Broadband (MBB) slice B. Similar to the broadcast slice, this data stream is also conveyed to the CSP Core Network 14, specifically, the 5GC PCG (e.g., implemented in a network node 16 and/or other remote node, virtual node, core node, cloud node, server, etc.). Subsequently, it is sent to the SDWAN SSE 100 at the transport network 102, and ultimately directed towards the internet (e.g., intermediate network(s) 30) or other equivalent external networks.

The example system of FIG. 5 further includes a CSP Operations Support System/Business Support System (OSS/BSS) 107, which is configured for providing service ordering and orchestration functions. The CSP OSS/BSS may be implemented, e.g., in a network node 16, virtual node, server, etc. A device performance dashboard (e.g., enterprise dashboard) 108 is provisioned as part of the system, which offers information and configurability options related to slice performance, service ordering, device Application Programming Interface (API), and service assurance, for example. The CSP OSS/BSS 107 maintains active communication with the CSP Core network 14.

The device performance dashboard (e.g., enterprise dashboard) 108 additionally collects network (NW) and subscriber information, deriving its data from various sources such as the 5GC Network Function (NF), SDWAN SSE, and other equivalent entities in the network ecosystem. This collected information contributes to the overall efficiency and performance of the system, supporting service assurance, network diagnostics, and system performance optimization.

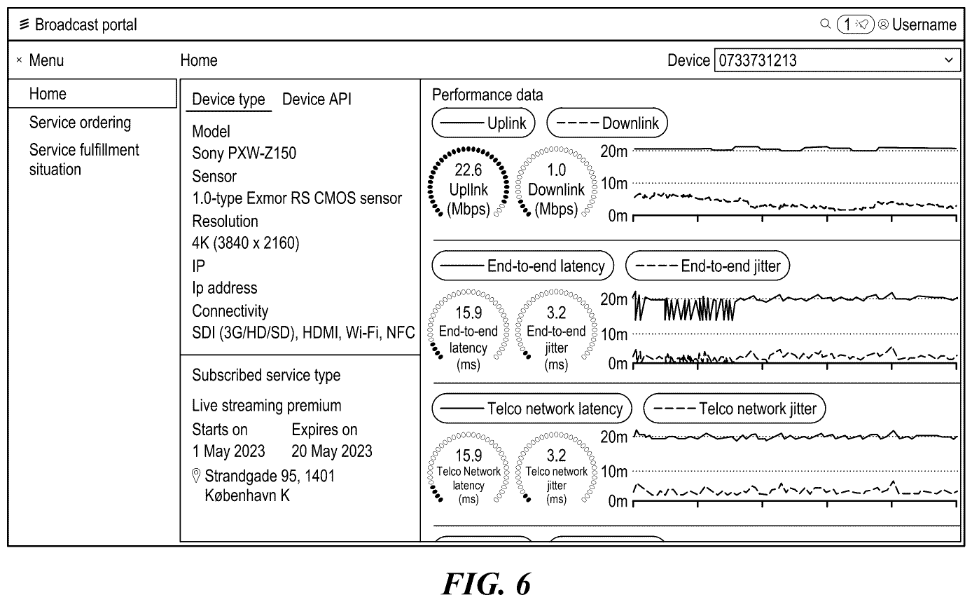

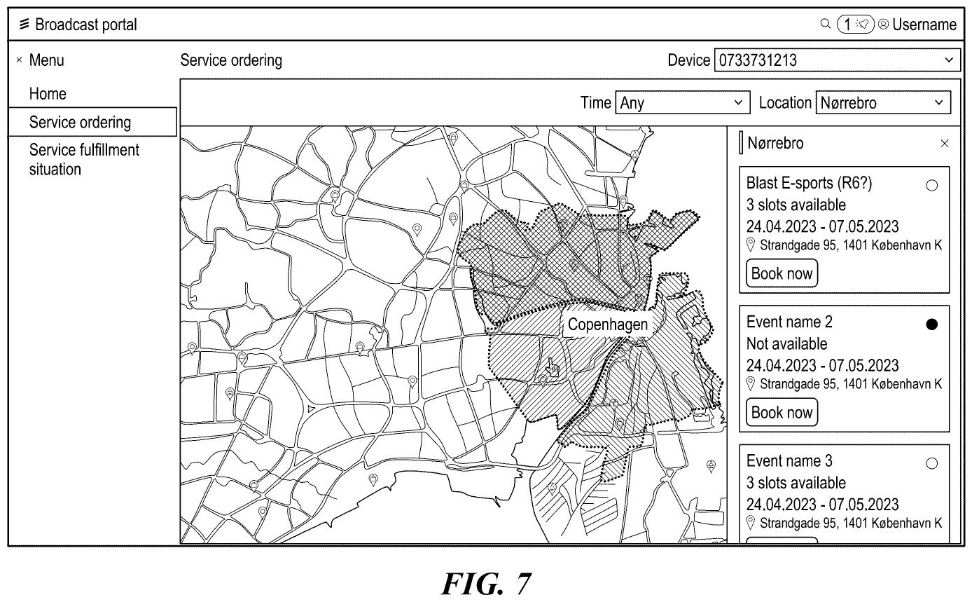

FIG. 6 and FIG. 7 are illustrations of example user interfaces for managing 5G slicing end-to-end, according to embodiments of the present disclosure. In FIG. 6, a user interface for network performance per device is provided in real time, including uplink/downlink speeds, end-to-end latency, end-to-end jitter, telco network latency, telco network jitter, model information, sensor information, IP address information, subscription information etc. In FIG. 7, a user interface for service ordering is provided, with three example service geographic areas associated with a device and/or subscription shown.

In addition to network performance reporting, service management based on WD 22 real time geographical location may be required in some embodiments to monitor WD 22 locations, e.g., based on geographical locations in a service activated time period. For a complete location based service, both periodic location monitoring and service management flow may be utilized.

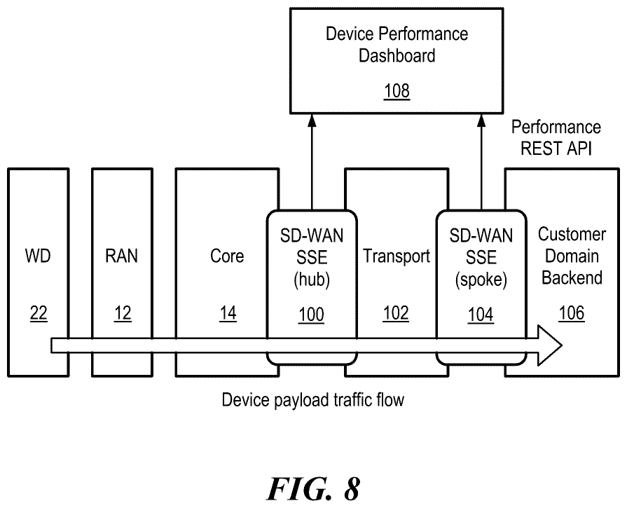

FIG. 8 is a block diagram illustrating an example for device payload traffic flow for device performance observability, according to some embodiments of the present disclosure. The flow begins at the WD 22, and is transmitted from the WD 22 to the RAN 12, then to the core network 14. The flow proceeds to a SD-WAN SSE (hub) 100 at the interface between the core network 14 and the transport network 102, to the transport network 102, then to an SD-WAN SSE (spoke) 104 at the interface between the transport network 102 and the customer domain backend 106. A device performance dashboard 108 communicates with the SD-WAN SSE (hub) and/or the SD-WAN SSE (spoke), e.g., for a performance REST API. It is to be understood that each of the SD-WAN 100, transport network 102, SD-WAN SSE 104, customer domain backend 106, and device performance dashboard 108, may be implemented in one or more of a network node 16, a wireless device 22, a virtual node/server, core node/server, cloud node/server, etc.

In some embodiments, the SD-WAN 100 may be deployed as a hub (e.g., after the N6 interface on the telco side) and as a spoke (e.g., on an enterprise end side) setup. A major edge point for observability is typically on the hub side for all devices.

The SD-WAN 100 may be integrated with N6 interfaces with packet gateways on the hub side, which may be utilized both as an edge active probe sending constant test traffic towards device WD 22 end and enterprise server end (e.g., customer domain backend 106). Jitter and latency on both the telco end (i.e., RAN 12 plus Core network 14) and transport side 102 may be retrieved on the order of seconds.

The same SD-WAN 100 end point at telco edge may act as a passive probe to monitor throughput performance for both uplink and downlink traffic for the WD 22.

An REST API queried by the device IP or WD 22 identifier may be used for reporting on current jitter and latency on both the telco edge and the transport network 102. The WD 22 throughput may also be reported on both the uplink and the downlink rate through the same REST API. The performance data refreshing on external portal may depend on the REST API client retrieval frequency, for example.

The WD 22 probing through the SD-WAN 100 edge may be based on WD 22 IP information. The WD 22 device identification mapping towards IP may be provided through the telco network intelligence by one or more of:
1. 5GC NF intelligence through Radius in 5G NSA and SMF/BSF/NEF in 5G SA
2. A pre-defined fixed IP network configuration

When offering slicing services, the division or partitioning of radio resources typically occurs at the cluster level to ensure reliable service delivery across a large group of cells. However, mapping these divisions to actual geographical locations can be challenging, as the physical location may either be smaller than the cluster area, overlap with parts of several cluster areas, or fall on the boundary of one or more clusters. Moreover, due to geographical constraints or environmental conditions, the serving cell may sometimes deviate from the predefined cluster location, necessitating line-of-sight connectivity.

Embodiments of the present disclosure may provide a system to decouple the geographical service location from the radio network cell/cluster grouping. This system may be based on real-time reporting of WD 22 location estimations. A service rooted in real geographical locations follows the service flows described below.

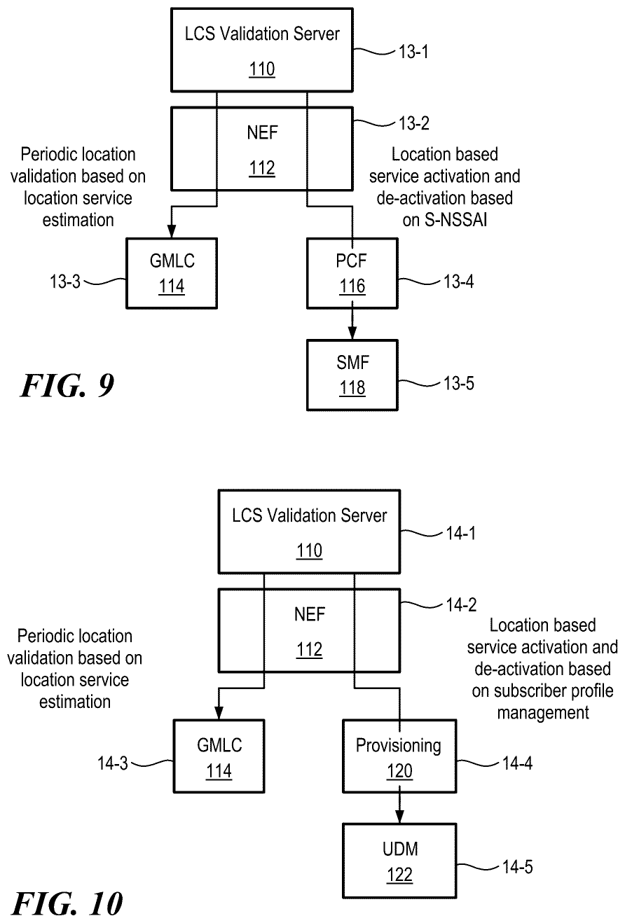

FIG. 9 illustrates an example flowchart of a process for location-based service validation, according to some embodiments of the present disclosure, according to the following steps:

Step 13-1: Location-based service validation takes into account both the service location/area and the service subscription time period. Periodic requests are sent to the Gateway Mobile Location Center (GMLC) 114 via the Network Exposure Function (NEF) 112 to monitor the WD 22 location for service validation. An alternative approach could be sending a geofencing area to the NEF 112, with the validation result being verified in the NEF 112 based on GMLC's 114 report on the WD 22 location.

Step 13-2: Based on the validation result from Step 13-1, a process is triggered towards NEF 112 for location-based service activation and deactivation.

Step 13-3: In the context of 5G Standalone Architecture (5G SA), the LCS validation server 110 triggers the NEF 112, which in turn triggers the GMLC 114, for periodic location validation based on location service estimation.

Step 13-4 The NEF 112 triggers the Policy Control Function (PCF) 116 for Single Network Slice Selection Assistance Information (S-NSSAI) modification (e.g., location based service activation and de-activation based on S-NSSAI).

Step 13-5: The PCF 116 triggers the SMF 118 for S-NSSAI modification.

FIG. 10 is a flowchart illustrating an example process for location based service validation, e.g., in a 5G NSA system, in which the NEF 112 triggers the provisioning system 120 upon detecting a subscriber portfolio change in the UDM 122, according to one or more embodiments of the present disclosure, according to the following steps:

14-1: The LCS validation server 110 sends requests to the NEF 112 for either periodic location validation based on location service estimation or location based service activation and de-activation based on S-NSSAI.

14-2: The NEF 112 receives the request(s) and forwards them to the GMLC 114 and/or provisioning system 120.

14-3: The GMLC 114 receives the requests, and performs periodic location validation based on location service estimation.

14-4: In the context of 5G NSA, the provisioning system 120 sends a request to the UDM 122 for location based service activation and de-activation based on subscriber profile management.

14-5: The UDM 122 receives the request from the provisioning system 120 and performs location based service activation and de-activation based on subscriber profile management.

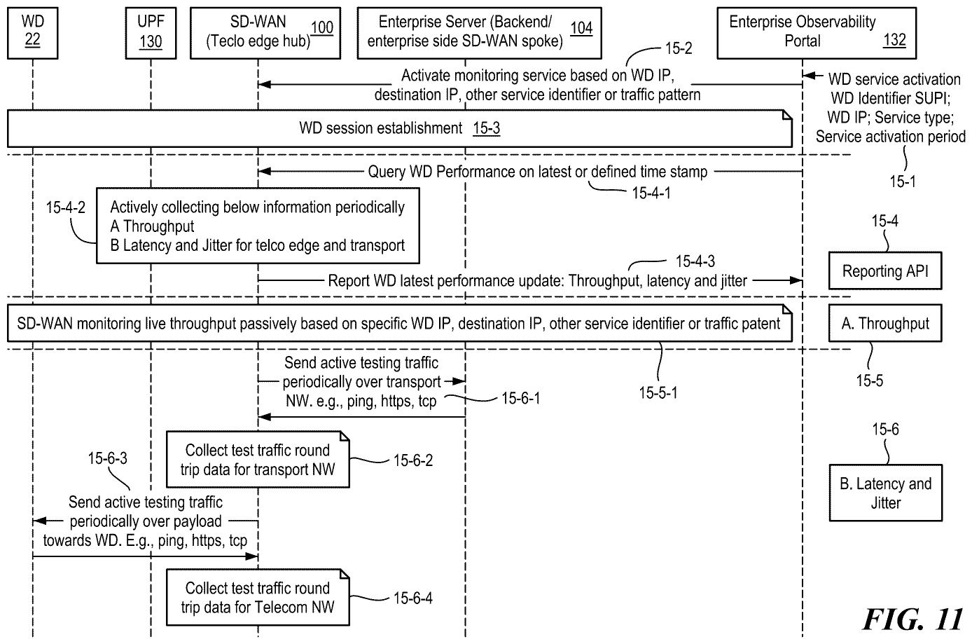

FIG. 11 is a flowchart illustrating an example process for observability with REST API reporting for WD 22 performance in telco and transport network in real time, according to some embodiments of the present disclosure. The reporting API includes both Throughput and Latency and jitter from both the telco side (including the radio and core networks) and the transport side (i.e., from the telco edge to the enterprise server edge). The following steps are described in FIG. 11:

Step 15-1: WD 22 service activation information (e.g., WD (UE) identifier SUPI, WD (UE) IP, service type, service activation period, etc.) is provided to an enterprise observability portal 132 (e.g., implemented in a network node 16 and/or other remote node, virtual node, core node, cloud node, server, etc.).

Step 15-2: The enterprise observability portal 132 signals the SD-WAN (telco edge hub) 100 with signaling to activate monitoring service based on WD IP (UE IP), destination IP, other service identifier(s) or traffic pattern, etc.

Step 15-3: A UE session (WD session) establishment is performed at/by the WD 22, UPF 130 (e.g., implemented in a network node 16 and/or other remote node, virtual node, core node, cloud node, server, etc.), SD-WAN (telco edge hub) 100 (e.g., implemented in a network node 16 and/or other remote node, virtual node, core node, cloud node, server, etc.), and enterprise server (backend/enterprise side SD-WAN spoke) 104 (e.g., implemented in a network node 16 and/or other remote node, virtual node, core node, cloud node, server, etc.).

Step 15-4: A reporting API process is performed, including the following steps:
Step 15-4-1: For the reporting API process, the enterprise observability portal 132 queries the SD-WAN (telco edge hub) 104 for WD 22 performance, e.g., on a latest or defined time stamp.
Step 15-4-2: Continuing the reporting API process, the SD-WAN (telco edge hub) 100 actively collects information periodically, such as throughput and latency/jitter for telco edge and transport, for example.
Step 15-4-3: Completing the reporting API process, the SD-WAN (telco edge hub) 100 reports the WD 22 latest performance update, e.g., information corresponding to throughput, latency, jitter, etc., to the enterprise observability portal 132.

Step 15-5: A throughput reporting process is performed, including the following steps:
Step 15-5-1: The WD 22, UPF 130, SD-WAN 104, and/or SD-WAN 100 performs monitoring of live throughput, e.g., passively, based on a specific UE IP (WD 22 IP), destination IP, other service identifier(s) or traffic pattern.

Step 15-6: A latency and jitter reporting process is performed, including the following steps:
Step 15-6-1: The SD-WAN (telco edge hub) 100 sends/receives, to/from enterprise server (backend/enterprise side SD-WAN spoke) 104, active testing traffic periodically over the transport network 102, e.g., via ping, http, TCP, etc.
Step 15-6-2: Continuing the latency and jitter reporting process, the SD-WAN (telco edge hub) 100 collects test traffic round trip data for the transport network 102.
Step 15-6-3: Continuing the latency and jitter reporting process, the SD-WAN (telco edge hub) 100 sends/receives active testing traffic periodically over payload(s) towards the WD 22, e.g., via ping, http, TCP, etc.
Step 15-6-4: Continuing the latency and jitter reporting process, the SD-WAN (telco edge hub) 100 collects test traffic round trip data for the telecom network.

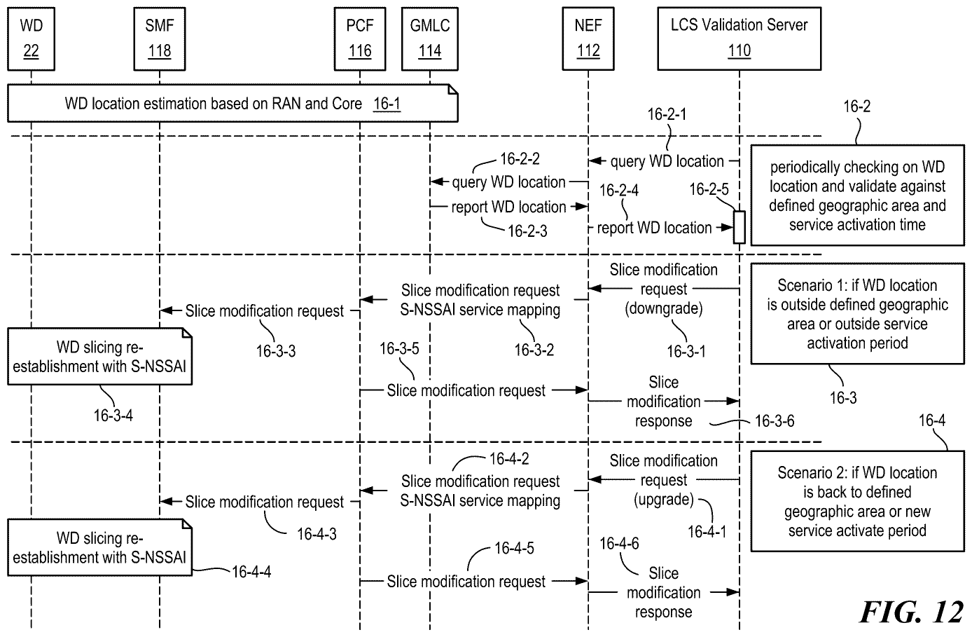

FIG. 12 is a flowchart illustrating an example process for location based service activation/deactivation for network slicing in the context of a 5G SA architecture, according to some embodiments of the present disclosure. The following steps are described in FIG. 12:

Step 16-1: WD 22 location estimation based on RAN 12 and core network 14 is performed by the WD 22, SMF 118, PCF 116, and GMLC 114.

Step 16-2: The LCS validation server 110 performs periodic checking on the WD 22 location and validates against a defined geographic area and service activation time, including:
Step 16-2-1: The LCS validation server 110 queries the NEF 112 for the WD 22 location information.
Step 16-2-2: The NEF 112 queries the GMLC 114 for the WD 22 location information.
Step 16-2-3: The GMLC 114 reports the WD 22 location information to the NEF 112.
Step 16-2-4: The NEF 112 reports the WD 22 location information to the LCS validation server.
Step 16-2-5: The LCS Validation processes the received WD 22 location information, e.g., for checking the WD 22 location and validation against the defined geographic area and service activation time, as described herein.

Step 16-3: In a first scenario, Scenario 1, if the WD 22 location is determined to be outside the defined geographic area or outside a service activation period, the following steps may be performed:
Step 16-3-1: The LCS validation server 110 signals a slice modification request (downgrade) to the NEF 112.
Step 16-3-2: The NEF 112 sends a slice modification request S-NSSAI service mapping to the PCF 116.
Step 16-3-3: The PCF 116 sends a slice modification request to the SMF 118
Step 16-3-4: The SMF 118 and WD 22 perform WD slicing re-establishment with S-NSSAI.
Step 16-3-5: The PCF 116 signals a slice modification response to the NEF 112.
Step 16-3-6: The NEF 112 signals a slice modification response to the LCS validation server 110.

Step 16-4: In a second scenario, Scenario 2, if the WD 22 location returns to the defined geographic area, or is subject to a new service activation period, the following steps may be performed:
Step 16-4-1: The LCS validation server 110 signals a slice modification request (upgrade) to the NEF 112.
Step 16-4-2: The NEF 112 signals a slice modification request NSSAI service mapping to the PCF 116.
Step 16-4-3: The PCF 116 signals a slice modification request to the SMF 118.
Step 16-4-4: The SMF and WD 22 perform WD 22 slicing re-establishment with S-NSSAI.
Step 16-4-5: The PCF 116 signals a slice modification response to the NEF 112.
Step 16-4-6: The NEF 112 signals a slice modification response to the LCS validation server 110.

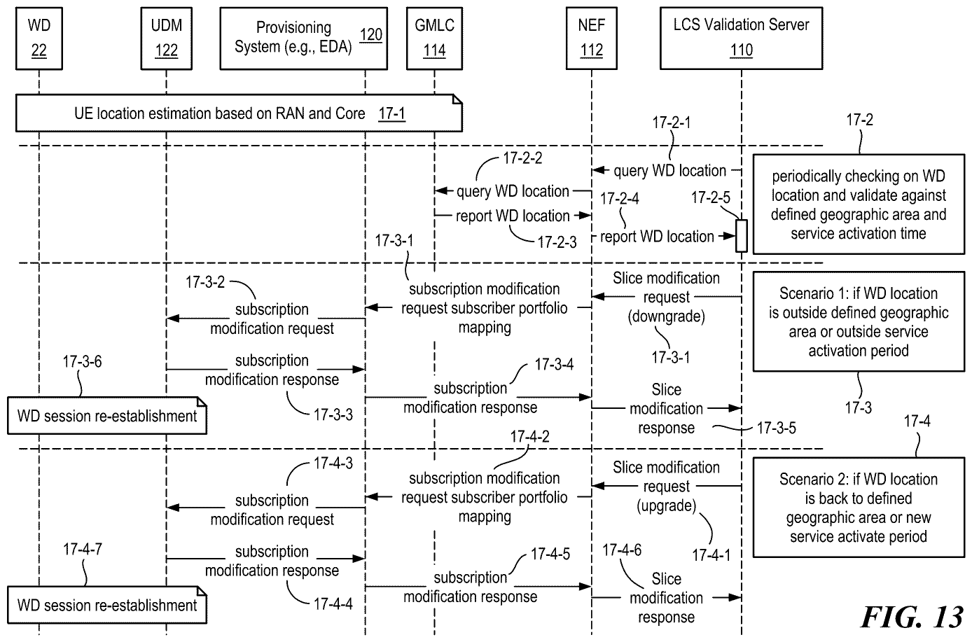

FIG. 13 is a flowchart illustrating an example process for location based service activation/deactivation for network partitioning in the context of 5G NSA. The following steps are described in FIG. 13:

Step 17-1: WD 22 location estimation based on the RAN 12 and the core network 14 is performed by WD 22, UDM 122, provisioning system 120, and GMLC 114.

Step 17-2: The LCS validation server 110 periodically checks on the WD 22 location and validates it against the defined geographic area and service activation time, including the follow steps:
Step 17-2-1: The LCS Validation server 110 queries the NEF 112 for the WD 22 location information.
Step 17-2-2: The NEF 112 queries the GMLC 114 for the WD 22 location.
Step 17-2-3: The GMLC 114 reports the WD 22 location to the NEF 112.
Step 17-2-4: The NEF 112 reports the WD 22 location to the LCS validation server 110.
Step 17-2-5: The LCS validation server 110 processes the received location information.

Step 17-3: In a first scenario, Scenario 1, if the WD 22 location is outside a defined geographic area or outside a service activation period, the following steps may be performed:
Step 17-3-1: The LCS validation server 110 sends a slice modification request (downgrade) to the NEF 112.
Step 17-3-2: The NEF 112 sends a subscription modification request subscriber portfolio mapping to the provisioning system 120.
Step 17-3-3: The UDM 122 sends a subscription modification response to the provisioning system 120.
Step 17-3-4: The provisioning system 120 sends a subscription modification response to the NEF 112.
Step 17-3-5: The NEF 112 sends a slice modification response to the LCS validation server 110.
Step 17-3-6: The WD 22 and UDM 122 perform WD session re-establishment.

Step 17-4: In a second scenario, Scenario 2, if the WD 22 returns to the defined geographic area or a new service activation period beings, the following steps may be performed:
Step 17-4-1: The LCS validation server 110 sends a slice modification request (upgrade) to the NEF 112.
Step 17-4-2: The NEF 112 sends a slice modification request to the provisioning system 120.
Step 17-4-3: The provisioning system 120 sends a subscription modification request to the UDM 122.
Step 17-4-4: The UDM 122 sends a subscription modification response to the provisioning system 120.
Step 17-4-5: The provisioning system 120 sends a subscription modification response to the NEF 112.
Step 17-4-6: The NEF 112 sends a slice modification response to the LCS validation server 110.
Step 17-4-7: the Wd 22 and Udm 122 Perform Wd Session Re-establishment.

It is to be understood that one or more of the SD-WAN SSE (hub) 100, transport network 102, SD-WAN SSE (spoke) 104, customer domain backend 106, device performance dashboard 108, LCS validation server 110, NEF 112, GMLC 114, PCF 116, SMF 118, provisioning system 120, UDM 122, UPF 130, and/or enterprise observability portal 132, may be implemented in one or more network node 16, and/or any other virtual node/server, core node/server, cloud node/server, etc.

### SOME EXAMPLES

Example A1. A location validation server 110 in a communication system configured to communicate with a wireless device (WD) 22 for validating a service request, the location validation server 110 configured to, and/or comprising a radio interface and/or comprising processing circuitry configured to:
receive network estimated location information for the WD 22 provided by a Gateway Mobile Location Centre (GMLC) 114;
validate the received network estimated location information against the service request;
modify, based on the validation, one of:
   a Network Slice Selection Assistance Information (NSSAI) through a Policy Control Function (PCF) 116; and
   a User Data Management (UDM) 122 subscriber profile; and
report real-time performance metrics for the WD 22.

Example A2. The location validation server 110 of Example A1, wherein the real-time performance metrics include one or more of throughput, latency, jitter and Quality of Experience (QoE) metrics.

Example A3. The location validation server 110 of any one of Examples A1 and A2, wherein the real-time performance metrics are derived from both a Radio Access Network (RAN) 12 and a core 14 transport side of the communication system.

Example B1. A method implemented in a location validation server 110 in a communication system configured to communicate with a wireless device (WD) 22 for validating a service request, the method comprising:
receiving network estimated location information for the WD 22 provided by a Gateway Mobile Location Centre (GMLC) 114;
validating the received network estimated location information against the service request;
modifying, based on the validation, one of:
   a Network Slice Selection Assistance Information (NSSAI) through a Policy Control Function (PCF) 116; and
   a User Data Management (UDM) 122 subscriber profile; and reporting real-time performance metrics for the WD 22.

Example B2. The method of Example B1, wherein the real-time performance metrics include one or more of throughput, latency, jitter and Quality of Experience (QoE) metrics.

Example B3. The method of any one of Examples A1 and A2, wherein the real-time performance metrics are derived from both a Radio Access Network (RAN) 12 and a core 14 transport side of the communication system.

Example C1. A Policy Control Function (PCF) 116 in a communication system is configured to communicate with a location validation server 110 for service request management, the PCF 116 configured to, and/or comprising a radio interface and/or comprising processing circuitry configured to:
receive a request for modification of a Network Slice Selection Assistance Information (NSSAI) based on the validation of network estimated location information for a wireless device (WD) 22 by the location validation server 110;
modify the NSSAI based on the received request; and
provide the modified NSSAI for service request management of the WD 22.

Example C2. The PCF 116 of Example C1, wherein the NSSAI modification request is influenced by one or more real-time performance metrics for the WD 22 including one or more of throughput, latency, jitter, and Quality of Experience (QoE) metrics.

Example C3. The PCF 116 of any one of Examples C1 and C2, wherein the real-time performance metrics influencing the NSSAI modification request are derived from both a Radio Access Network (RAN) 12 and a core 14 transport side of the communication system.

Example D1. A method implemented in a Policy Control Function (PCF) 116 in a communication system configured to communicate with a location validation server 110 for service request management, the method comprising:
receiving a request for modification of a Network Slice Selection Assistance Information (NSSA′I) based on the validation of network estimated location information for a wireless device (WD) 22 by the location validation server 110;
modifying the NSSAI based on the received request; and
providing the modified NSSAI for service request management of the WD 22.

Example D2. The method of Example D1, wherein the NSSAI modification request is influenced by one or more real-time performance metrics for the WD 22 including one or more of throughput, latency, jitter, and Quality of Experience (QoE) metrics.

Example D3. The method of any one of Examples D1 and D2, wherein the real-time performance metrics influencing the NSSAI modification request are derived from both a Radio Access Network (RAN) 12 and a core 14 transport side of the communication system.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
5GC Fifth Generation Core
A&A Authentication & Authorization
AF Application Function
AMF Access and Mobility Management Function
CP Control Plane
CUPS Control User Plane Separation
DMS Drone Management System
DNN Data Network Name
FAR Forwarding Action Rule
GPSI Global Public Subscription Identifier
IoT Internet of Things
NEF Network Exposure Function
NRF Network Repository Function
OPEX Operational Expenditure
OTT Over the Top
PCC Policy Charging and Control
PCEF Policy and Charging Enforcement Function
PCF Policy Control Function
PDI Packet Detection Information
PDR Packet Detection Rule
PDU Protocol Data Unit
PFCP Packet Forwarding Control Protocol
SLA Service Level Agreement
SM Session Management
SMF Session Management Function
SUPI Subscription Permanent Subscriber
Telco Telephone Company, e.g., service provider
UDM Unified Data Management
UDR Unified Data Repository
USS UAS Service Supplier
UE User Equipment
UPF User Plane Function

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a location validation server in a communication system configured to communicate with a wireless device the method comprising:
receiving network estimated location information for the wireless device provided by a Gateway Mobile Location Centre, GMLC,
validating the received network estimated location information against a service request;
modifying based on the validation, one of:
a Network Slice Selection Assistance Information, NSSAI, through a Policy Control Function, PCF, and
a User Data Management, UDM, subscriber profile; and
reporting real-time performance metrics for the wireless device.

2. The method of claim 1, wherein the real-time performance metrics include a throughput, metric.

3. The method of claim 2, wherein the real-time performance metrics are at a device level for the wireless device.

4. The method of claim 1, wherein the real-time performance metrics are derived from both a Radio Access Network, RAN, and a core transport side of the communication system.

5. The method of claim 1, comprising the modifying of the NSSAI through the PCF, wherein the modifying of the NSSAI through the PCF comprises
deactivation of a location based service.

6. The method of claim 1, comprising the modifying of the UDM subscriber profile, wherein the modifying of the UDM subscriber profile comprises
deactivation of a location based service.

7. A location validation server in a communication system configured to communicate with a wireless device the location validation server comprising:
processing circuitry configured to:
receive network estimated location information for the wireless device provided by a Gateway Mobile Location Centre, GMLC
validate the received network estimated location information against a service request;
modify, based on the validation, one of:
a Network Slice Selection Assistance Information, NSSAI, through a Policy Control Function, PCF, and
a User Data Management, UDM, subscriber profile; and
report real-time performance metrics for the wireless device

8-12. (canceled)

13. A method implemented in a Policy Control Function, PCF, in a communication system configured to communicate with a location validation server the method comprising:
receiving a request for modification of a Network Slice Selection Assistance Information, NSSAI, based on the validation of network estimated location information for a wireless device by the location validation server;
modifying the NSSAI based on the received request; and
providing the modified NSSAI for service request management of the wireless device.

14. The method of claim 13, wherein the NSSAI modification request is influenced by one or more real-time performance metrics for the wireless device including one or more of throughput, latency, jitter, and Quality of Experience, QoE, metrics.

15. The method of claim 14, wherein the real-time performance metrics are at a device level for the wireless device.

16. The method of claim 13, wherein the real-time performance metrics influencing the NSSAI modification request are derived from both a Radio Access Network, RAN, and a core transport side of the communication system.

17. The method of claim 13, wherein the NSSAI modification request comprises
deactivation of a location based service.

18-22. (canceled)

23. The method of claim 1, wherein the real-time performance metrics include a latency metric.

24. The method of claim 1, wherein the real-time performance metrics include a jitter metric.

25. The method of claim 1, wherein the real-time performance metrics include a Quality of Experience, QoE, metric.

26. The method of claim 1, wherein the modifying of the NSSAI through the PCF comprises activation of a location based service.

27. The method of claim 1, wherein the modifying of the UDM subscriber profile comprises activation of a location based service.
